(19) United States
(12) Patent Application Publication
(10) Pub. No.: US 2020/0028308 A1
(43) Pub. Date: Jan. 23, 2020

(54) Electrical outlet relocation device

(71) Applicant: Judy E. Harding, Easton, MD (US)

(72) Inventor: Judy E. Harding, Easton, MD (US)

(21) Appl. No.: 15/797,076

(22) Filed: Oct. 30, 2017

(51) Int. Cl. H01R 25/00; H01R 25/14; H01R 35/04

(52) U.S. Cl. CPC H01R 25/003; H01R 35/04; H01R 25/14

(57) ABSTRACT

The invention is directed to an extension cord for use with heavy furniture. The extension cord provides an insertion module with prongs which may be inserted into an existing wall outlet, and a rigid, telescoping conduit extending laterally from the wall outlet to provide an extension outlet at a more convenient location. The insertion module also serves as a rotating base, such that the conduit may be rotated a full 180° around the insertion module. The extension cord may also be rotated, and may be secured to the wall with hook and loop fasteners.

### CROSS-REFERENCE TO RELATED APPLICATIONS

This Application claims the benefit of U.S. Provisional Application No. 62/414,067, filed Oct. 28. 2016, which is hereby incorporated by reference.

### STATEMENT REGARDING FEDERALLY SPONSORED RESEARCH OR DEVELOPMENT

Not Applicable

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to household electrical accessories and in particular to an extension cord for use with heavy furniture. There are many types of furnishings in the home, such as couches, major appliances, home entertainment centers, pianos, and bookcases filled with books, which are extremely heavy. These frequently cover up electrical outlets mounted low on the wall, near the floor. Unfortunately, due to the proliferation of modems, routers, personal computers, and other large consumer electronics, as well as personal devices such as smartphones and tablets which need to be recharged, the availability of these wall outlets for immediate and frequent use has become extremely important for tens of millions of households.

A search of the prior art reveals various devices which have been developed to provide means to solve the problems often found in extension cords. Conventional extension cords are easily damaged by heavy furniture nearby, and can frequently become unplugged. None are closely related to the present invention, but several include features which resemble those of the present invention. Each has proven to be less than satisfactory in its own way.

Electric outlet extender, U.S. Pat. No. 6,004,138 (priority Oct. 31, 1995), provides a male plug at one end to be connected into a wall outlet and a female electrical outlet at an opposite end and with one or more tubular members connected between the male plug and the female outlet. The tubular members are connected to each other through a slidable, rotatable or both slidable and rotatable means, thereby permitting the extender to be easily adjusted and adapted to fit the widest variety of electrical extension requirements, while maintaining a desired length and position and while avoiding the drawbacks of coils of standard extension cords.

Surgical retractor blade and system, U.S. Pat. No. 7,220,228 (priority May 4, 1999), provides a retractor apparatus having one or more opposing blades having a channel adapted to engage an incision in a patient, for the purpose of accessing and stabilizing the heart during surgery. The retractor blades may have features to cooperatively engage an instrument mount. The instrument mount preferably is configured to hold an instrument, such as a tissue stabilizer, and allows the instrument to be easily maneuvered. The retractor blades may have a number of suture locks for securing sutures used during surgery. The retractor system is particularly useful in accessing, positioning and stabilizing the beating heart for coronary artery bypass graft surgery.

Outlet device with changeable position features, U.S. Pat. No. 7,824,185 (priority Jul. 6, 2004), provides a device including at least one of outlet-unit with a plurality of resilient contacts and socket-set receiving-areas to connect with a device's electricity supply bus to deliver an electric signal from an electric signal source to the socket-set receiving-areas. The position of the outlet-units is changeable when a force is applied to an outlet-unit or outlet-device, enabling the outlet device to accommodate all different sizes of plug.

Adjustable positionable electrical outlet, U.S. Pat. No. 4,245,873 (filed Mar. 8, 1979), provides an electrical outlet including telescopic members having plug and socket connectors on their remote ends and adjustable to select a desired distance between the plug and socket.

Safety cord plug adaptor for electric outlet boxes, U.S. Pat. No. 3,775,729 (filed May 1, 1972), provides a safety protective cover for an electrical wall outlet which includes hollow housing, and means for releasably affixing same over at least one plug-in receptacle of outlet with plug-in electric cord extending from housing. Stop means are provided on the cord and housing, after plugging the cord in a receptacle and subsequent attachment of the housing to wall outlet, effective independently of the plug to prevent unplugging of the same due to a child tugging on the cord.

Some of the prior art inventions present certain disadvantages. The present invention has been developed for the purpose of addressing and resolving these disadvantages. An extension cord for use with heavy furniture, which provides a rigid, telescoping conduit extending laterally from the existing wall outlet to provide a new outlet at a more convenient location, would resolve this problem.

### SUMMARY OF THE INVENTION

Accordingly, the invention is directed to an extension cord for use with heavy furniture. The extension cord is designed to be sturdy and reliable, for use in a more challenging environment where more conventional extension cords would be easily damaged. The extension cord provides an insertion module with prongs which may be inserted into an existing wall outlet, and a rigid, telescoping conduit extending laterally from the wall outlet to provide an extension outlet at a more convenient location. The insertion module also serves as a rotating base, such that the conduit may be rotated a full 360° around the insertion module. The extension cord may also be rotated, and may be secured to the wall with hook and loop fasteners.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrate two embodiments of the invention and, together with the description, serves to explain the principles of the invention.

FIG. 1 is a front view of the first exemplary embodiment with the extension outlet in the horizontal position, displaying the insertion module 10, the conduit 11, and the extension outlet 12.

FIG. 2 is a front view of the first exemplary embodiment with the extension outlet in the vertical position, displaying the insertion module 10, the conduit 11, and the extension outlet 12.

FIG. 3 is a front view of the first exemplary embodiment, with the conduit rotated 90° and retracted, displaying the insertion module 10, the conduit 11, and the extension outlet 12.

FIG. 4 is a front view of the first exemplary embodiment, with the conduit rotated 90° and extended, displaying the insertion module 10, the conduit 11, the sleeve 11A, and the extension outlet 12.

FIG. 5 is a front perspective view of the double extension outlet of the second exemplary embodiment, displaying the double extension outlet 13.

FIG. 6 is a front view of the conduit of the first exemplary embodiment with the sleeve removed, displaying the conduit 11, the sleeve 11A, and the cord 11B.

FIG. 7 is a rear perspective view of the insertion module of the first exemplary embodiment, displaying the insertion module 10, the prongs 10A, the aperture 10B, and the rotation dial 10C.

FIG. 8 is a front view of the first exemplary embodiment, with the conduit rotated 180° and extended, and the extension outlet in the horizontal position, displaying the insertion module 10, the conduit 11, the sleeve 11A, and the extension outlet 12.

FIG. 9 is a front view of the first exemplary embodiment with the conduit rotated 180° and extended, and the extension outlet in the vertical position. displaying the insertion module 10. the conduit 11. the sleeve 11A, and the extension outlet 12.

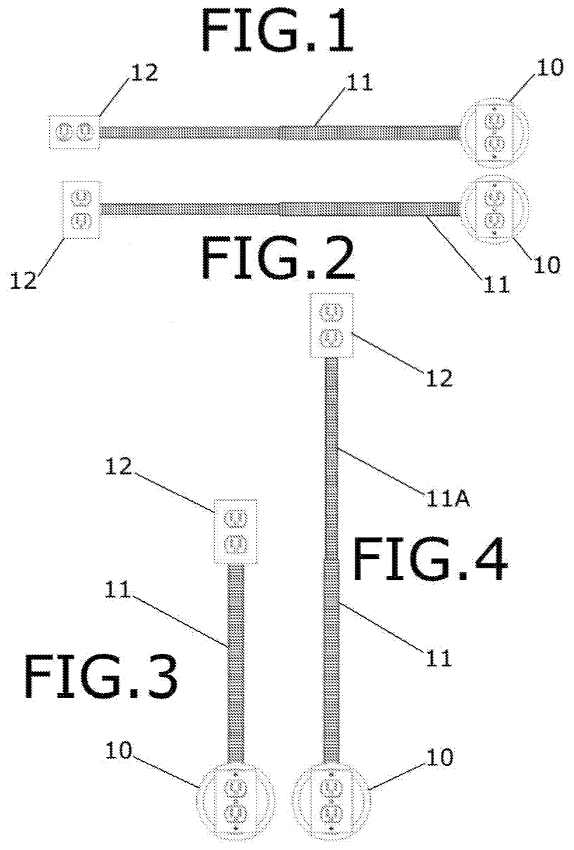

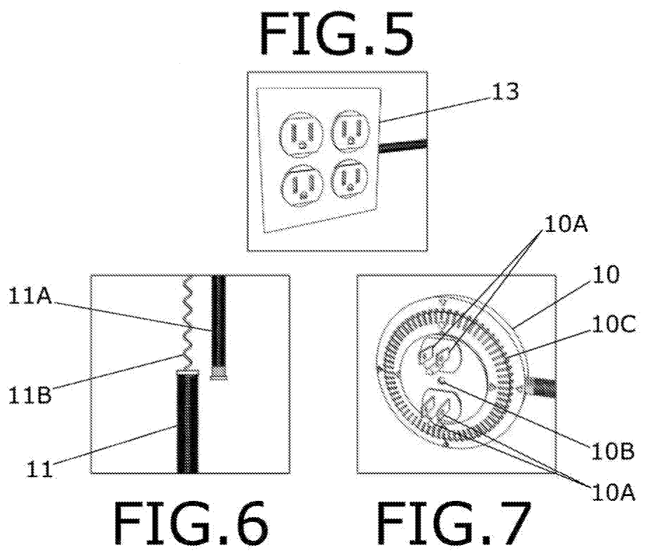

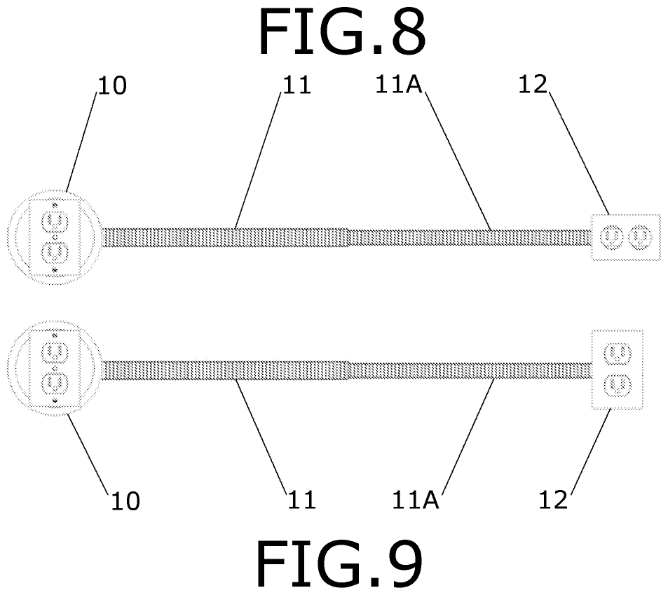

### DETAILED DESCRIPTION OF THE INVENTION

Referring now to the invention in more detail, the invention is directed to an extension cord for use with heavy furniture.

The first exemplary embodiment is comprised of a rotating circular insertion module 10, which is intended for insertion into the existing wall outlet; a telescoping conduit 11 comprised of two sections; and a rectangular extension outlet 12, providing two grounded outlets. Preferably, the conduit 11 is four feet in length, with a smaller gauge sleeve 11A telescoping in to shorten the overall length as desired. Alternate embodiments, wherein the conduit 11 is comprised of more than two sections and extends to a length greater than four feet, are contemplated.

The insertion module 10 provides prongs 10A for insertion into the wall outlet to draw electric power, and a circular aperture 10B at the center of the insertion module 10, enabling the user to semi-permanently mount the insertion module 10 on the wall outlet using a screw, which is provided. Alternately, the insertion module 10 may be secured to the wall using hook and loop fasteners, adhesive strips, or some other type of fastener. A rotation dial 10C is provided on the rear surface of the insertion module 10, enabling the user to easily rotate the conduit 11 to the same angle when relocating the device.

Like the insertion module 10, the extension outlet 12 rotates through a 360° arc in relation to the conduit 11, providing a significant improvement over the prior art. Preferably, the extension outlet 12 may be secured to the wall using hook and loop fasteners.

The second exemplary embodiment is similar in structure and function to the first exemplary embodiment, with the following modification. The extension outlet 12 is replaced by a double extension outlet 13, which provides four outlets.

To use the first or the second exemplary embodiment, the user inserts the prongs 10A into the wall outlet, and secures the insertion module 10 to the wall, using a screw, hook and loop fasteners, or other fasteners which are provided. The user may then rotate the conduit 11 and extend the sleeve 11A as desired, to position the extension outlet 12 in a convenient location. The user may then secure the extension outlet 12 to the wall, using hook and loop fasteners which are provided, and plug power cords from appliances, personal electronic devices, and other items into the outlets which are provided on the extension outlet 12.

The insertion module 10, the conduit 11, and the extension outlet 12 are preferably manufactured from rigid, durable materials, such as aluminum alloy, plastic, steel, and acrylic polymer. The cord 11B is preferably manufactured from copper alloy wire sheathed in plastic.

Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. An electrical outlet relocation device, which provides a rotating circular insertion module, which is intended for insertion into the existing wall outlet; a telescoping conduit comprised of two sections

2. The electrical outlet relocation device of claim 1, wherein a rectangular extension outlet, providing two grounded outlets, is provided.

3. The electrical outlet relocation device of claim 1, wherein the conduit is preferably four feet in length, with a smaller gauge sleeve telescoping in to shorten the overall length as desired.

4. The electrical outlet relocation device of claim 1, wherein the insertion module provides prongs for insertion into the wall outlet to draw electric power, and a circular aperture at the center of the insertion module 10, enabling the user to semi-permanently mount the insertion module on the wall outlet using a screw, which is provided.

5. The electrical outlet relocation device of claim 1, wherein the insertion module may be secured to the wall using hook and loop fasteners, adhesive strips, or some other type of fastener.

6. The electrical outlet relocation device of claim 1, wherein the insertion module and the extension outlet rotate through a 360° arc in relation to the conduit.

7. The electrical outlet relocation device of claim 1, wherein the extension outlet may be secured to the wall using hook and loop fasteners.

8. The electrical outlet relocation device of claim 2, wherein a double extension outlet, providing four grounded outlets, is provided.
